(19) United States
(12) Patent Application Publication
(10) Pub. No.: US 2011/0196927 A1
(43) Pub. Date: Aug. 11, 2011

(54) Social Networking Application Using Posts to Determine Compatibility

(76) Inventor: Richard Allen Vance, Las Vegas, NV (US)

(21) Appl. No.: 13/019,335

(22) Filed: Feb. 2, 2011

Related U.S. Application Data
(60) Provisional application No. 61/303,215, filed on Feb. 10, 2010.

(51) Int. Cl. G06F 15/16

(52) U.S. Cl. 709/204

(57) ABSTRACT

A social networking and compatibility application that analyzes behavioral data from users to determine compatibility between users. The application monitors the data of users during the user's normal daily routine. The data is gathered, screened and analyzed to build a profile of the user based on their thoughts, feelings, beliefs, likes, dislikes, interests, activities, political views, plans and any other personal traits revealed through the individual's posts. Based on an analysis of the user's profile, the social networking application will make connection recommendations and provide them to the individual. The profile building process is continuous and follows the user over time. As new information is received and analyzed, the user profile changes to reflect any new traits detected in the user's data.

### RELATED UNITED STATES APPLICATION DATA

This application claims priority benefit from U.S. Provisional Application No. 61/303,215, filed on Feb. 10, 2010.

### BACKGROUND

Social networking services provide users with the opportunity to make connections and stay in touch with others through the sharing of friendships, family bonds and professional connections. Users interact with each other on topics covering anything and everything, including but in no way limited to music, sports, religion, politics, travel, hobbies, personal interests, dating, romance, work, professional growth, etc., as well as just about any other topic a person might think about, comment on or do. The popularity of general social networking has exploded in recent years as free social networking sites like Facebook, MySpace, Friendster, Twitter and others have attracted millions of users around the world.

Other networking sites are focused on a particular subject. For example, match.com and eharmony.com are dating sites that seek to connect individuals based on common interests and personality traits. By identifying compatibility factors, these sites claim to be able to match up individuals for successful long term relationships. The typical approach for internet dating applications is to request that the user complete a profile form describing their interests and attributes. The site then matches individuals to each other depending on the answers to the questions on the profile form.

Matching individuals based on their answers to profile questions is unreliable. While most people are likely to answer the questions honestly, the answers are frequently inaccurate because individuals' subjective perception of themselves may be different from how other people view that person. For that reason, predicting the success of long term relationships based on answers to a questionnaire may not prove effective.

The present invention is a social networking and compatibility application that uses posts and other monitored data to determine compatibility between users. Rather than asking a person to complete a questionnaire, information about a person is gathered based on their ongoing posts and other interactions on one or more websites that they are already using such as Facebook, MySpace, Yelp, Netflix, etc. as well as other websites frequented by users posting posts that are currently in existence. In addition, other websites that may be launched in the future can also be tied to the social networking and compatibility application to gather more data about a particular user. Through their regular postings on these types of sites, an individual reveals a complex and intimate profile of himself or herself and their behavioral traits without always consciously intending to do so. Assessing and analyzing these posts as the raw data, a true and accurate picture of a person can be rendered that becomes the basis for a profile. The more data that is collected over time, the more precise the user profile becomes. Once that profile is established, it is continually updated with new information from new posts and can be used to match others who are potentially compatible with that person. The longer the time period for collecting data, the more posts assessed and the more accurate the profile becomes, resulting in a greater likelihood of success in predicting a compatible relationship between two users.

### BRIEF DESCRIPTION OF THE DRAWINGS

For a better understanding of the present invention, and to describe its operation, reference will now be made, by way of example, to the accompanying drawings. The drawings show preferred embodiments of the present invention in which:

FIG. 1 illustrates a social networking application system;

FIG. 2 illustrates a step for setting up a user for profiling;

FIG. 3 illustrates a step for gathering information about a user to build a user profile;

FIG. 4 illustrates a step for retrieving and storing user profile data from a social networking application;

FIG. 5 is a flowchart showing the process for parsing and scoring posts;

FIG. 6a is a sample table illustrating sample attributes with associated example collection methods and score calculations;

FIG. 6b is a sample table illustrating calculated scores for sub-attributes.

FIG. 7a is a sample chart showing a comparison between two members of the compatibility website;

FIG. 7b is a simple table showing the comparison of the scores of a first user to a second user to arrive at a correlation score for an attribute;

FIG. 8 is a sample table showing users with scoring for different profile attributes; and

FIG. 9 shows an “attribute mixer” that allows a user to set the weighting of different profile attributes.

### DETAILED DESCRIPTION OF THE INVENTION

The present invention will now be described more fully with reference to the accompanying drawings. It should be understood that the invention may be embodied in many different forms and should not be construed as limited to the embodiments set forth herein. Throughout the Figures, like elements of the invention are referred to by the same reference numerals for consistency purposes.

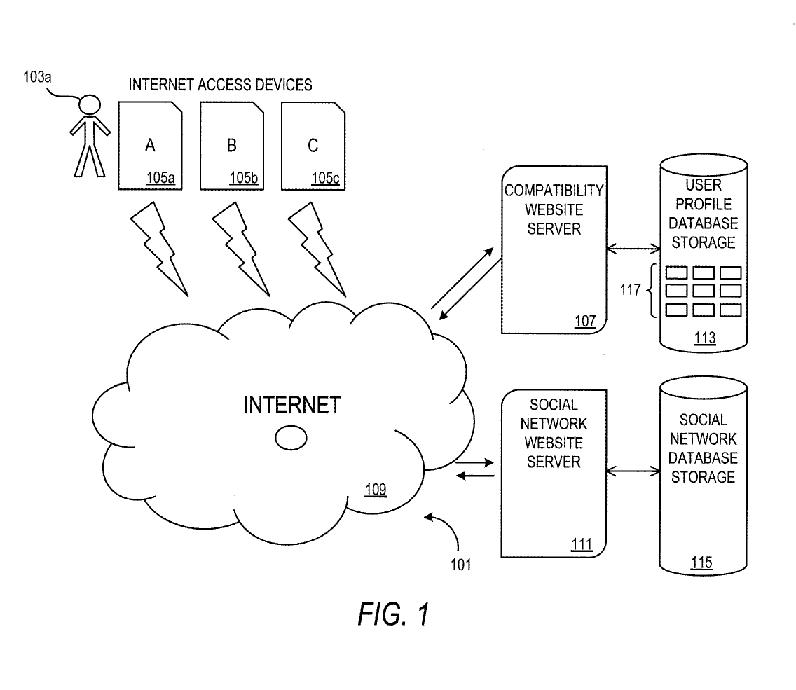

Shown in FIGS. 1-9 is a system and method for using user posts to develop criteria for compatibility between two or more users. In FIG. 1, a system 101 is shown for implementing the system and method of the present disclosure. A user 103a interacts with an internet access device 105a (such as a computer, a smartphone or other mobile device, or a terminal) for accessing a compatibility website server 107 over a network. Other users access the internet using devices 105b, 105c. The network may be a closed network, or it may be a public network such as the world wide web, referred to herein as the Internet 109. Compatibility website server 107 is programmed to offer a network application for generating compatibility recommendations, and is connected to a user profile database 113. A separate social networking website server 111 that provides a social networking application to users through internet 109 is connected to a social network database 115. It should be understood that there are a multitude of social network website servers present on the internet offering a variety of different social networking services and the number of such sites will continue to grow over time. Compatibility server 107 is designed to gather posts for a particular user from one or more of the social networking sites and the number of sites from which compatibility server 107 gathers posts is only limited by a particular user giving access authorization to compatibility server 107.

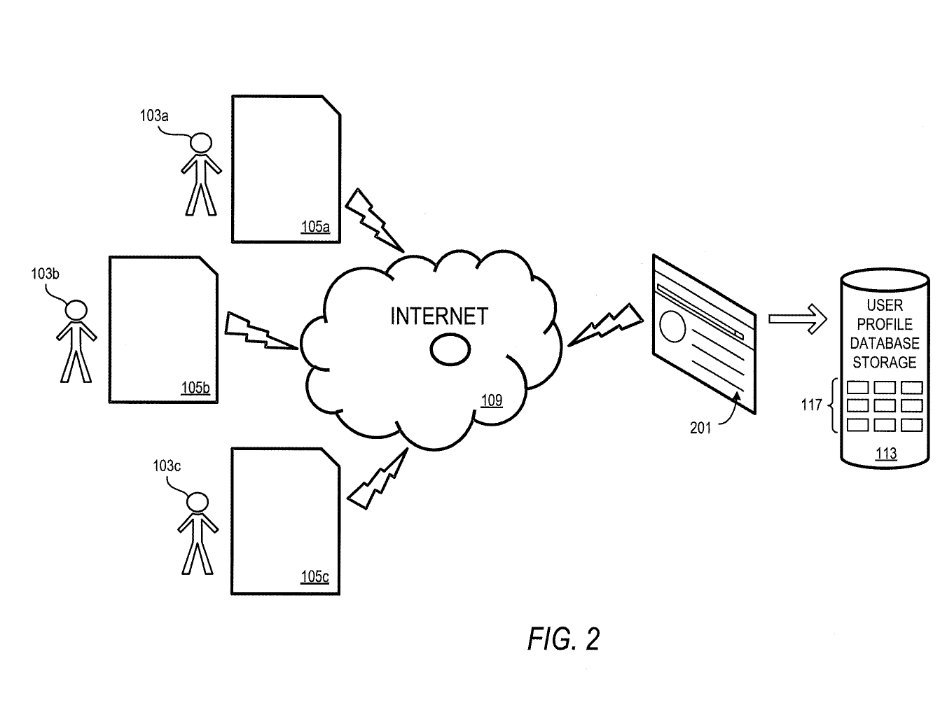

FIGS. 2-4 show a method for using system 101. In FIG. 2, user 103a begins by establishing a connection to Internet 109 on device 105a. User 103a then navigates to a website 201 that is rendered by website server 107 to provide compatibility recommendations based on the interpretation of posts or other data input by user 103a on one or more other websites such as Facebook, MySpace, Nefflix, or Twitter as well as numerous other sites that are available today or that may become available in the future. The term “post” will be used throughout this specification to refer to user postings on social networking sites, but it is also intended to encompass other types of data input by a user, such as user behaviors, user location information, user ratings and any other type of information that may be useful in characterizing a user on any website. As an example, a post may include a user's restaurant rating on the Yelp website or the rating of a movie on the Nefflix website. A post may also include a list of movies residing in a queue on Nefflix that a user has requested for viewing. With permission, such movie queue data can be collected by compatibility server 107 and used in developing a user profile.

Other users, 103b, 103c, etc. may also access website 201 for similar purposes through devices 105b, 105c, etc. On website 201, each user 103 creates a user account by providing basic information such as name, password, email, physical address, phone number, billing information such as credit card name and number, expiration date, and any other pertinent information required by an operator of website 201. The user account information is stored in user profile database 113 in one of multiple user storage areas 117. Each user 103 also grants permission to the operator of website 201 to access posts made by user 103 on one or more websites that user 103 uses. Once user 103 grants this permission, any posts made on the social networking sites are downloaded by compatibility server 107 to user profile database 113 from social network database 115 through compatibility website server 107, internet 109 and social network server 111. The more social networking sites that user 103 authorizes access to, the greater the number of posts and the resulting amount of data that is collected and processed over time about that user in area 117.

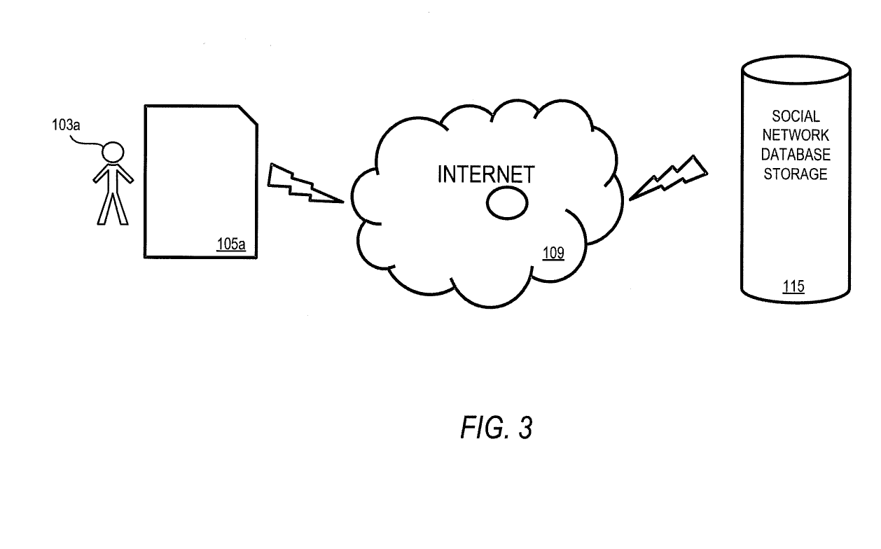

FIG. 3 shows the next step in the process where user 103a inputs information on device 105a in the form of a post on one or more of the social networking sites of which user 103a is a member. For example, user 103a may post on Twitter.com that “I had a great time singing karaoke last night at Expresso Yourself, NE Philly, can't wait until next week.” The data contained in this post is stored on social network database 115 with all of the other posts and information input by user 103 to the social networking site. This post may reveal significant information about user 103 including his or her location, interest in singing and future interest in getting together again. Similarly, a different type of post such as a user's Nefflix movie queue may reveal the types of movies that the user enjoys as well as particular actors, subject matter of interest and a host of other profile information about the user.

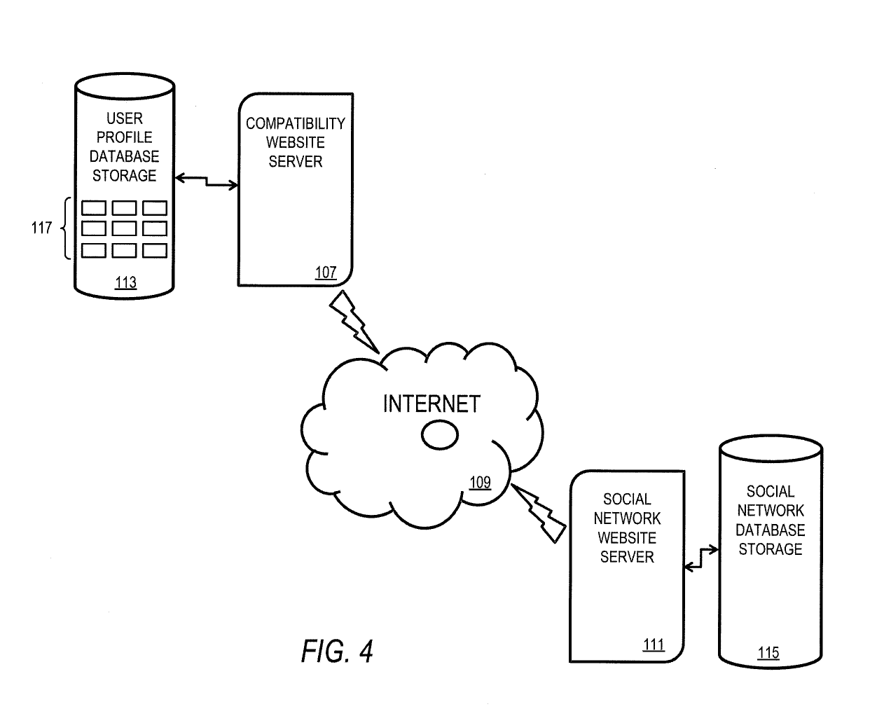

FIG. 4 shows the step of downloading data from social networking server 111 to compatibility website 107 across internet 109 via compatibility website server 107 and social network website server 111. At regular intervals, which may be once a week, twice a week or any other time period that is feasible for updating a user's profile, compatibility server 107 automatically downloads the complete set of posts for user 103 stored in social network database 115. The download action is permitted by social network server 111 because user 103 has previously granted permission for access during the account initiation process described with respect to FIG. 2. Compatibility server 107 retrieves the data using a protocol that uniquely identifies user 103. An example of the protocol used for communication between compatibility server 107 and social network server 111 to identify user 103 during data retrieval from Twitter may be as follows: screen_name@user; user_id:11111; status: I had a great time singing karaoke last night at Expresso Yourself, NE Philly, can't wait until next week. The post, along with all other posts made by user 103 on the social networking site is downloaded processed and possibly stored on user profile database 113 in the area 117 specifically reserved for data associated with individual user 103.

Once compatibility website 107 has downloaded a user's posts from the social networking sites for which access authorization has been granted, compatibility server 107 can review the posts to develop a user profile for user 103. The process of breaking down a post is referred to as parsing, and the overall process of rating post information to develop a user's profile is referred to as tokenization analysis. It should be understood that the more posts that are gathered, the more information compatibility website 107 has at its disposal to generate an accurate profile. As time passes and more posts are collected, the parsing and tokenization process will continue to add to the profile. Over time, a more complete profile is developed and the profile may change with the user's tastes. It is even possible that a user's views may completely change from one extreme to another. Such changes will be captured and reflected in the profile immediately, which is a significant improvement over prior compatibility systems using static questionnaires to profile users, even when those questionnaires are updated at a particular time interval. By using a rating system in the tokenization process that weights recent posts more heavily than older posts, a user profile changes as the user changes.

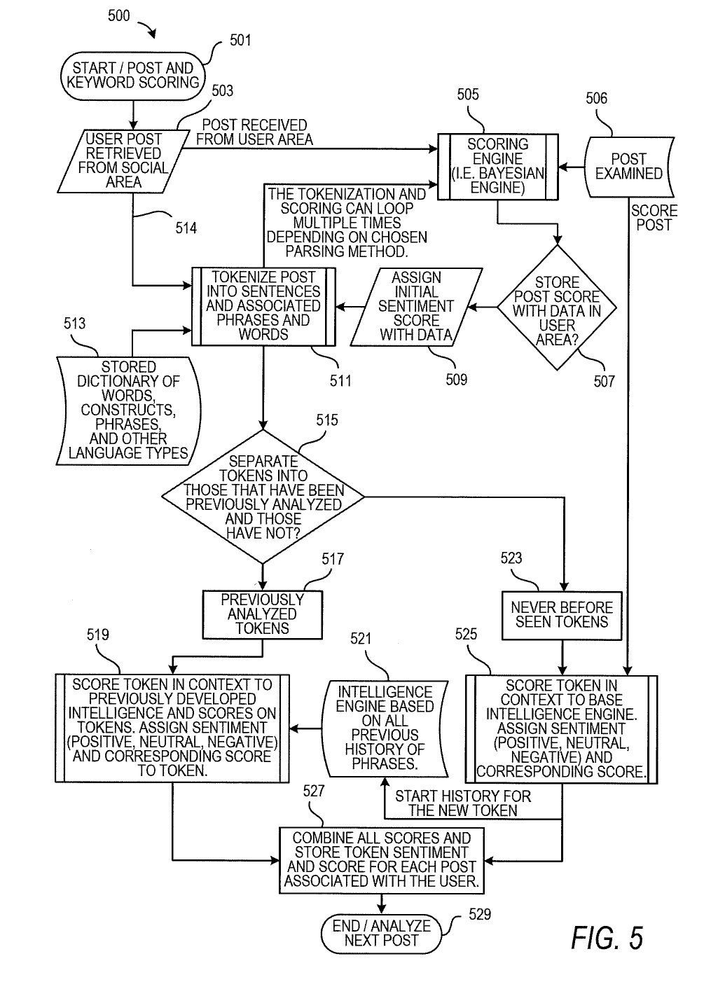

FIG. 5 is a flow chart 500 of the parsing and tokenization process starting with start step 501. A post is retrieved from user area 117 at step 503 and examined in step 505 using a computer associated with website 201 running an analysis process scoring engine, such as, but not limited to, a Bayesian probability engine.

Once the post is analyzed by the scoring engine, it is given a score in step 507 that may range from a negative to positive corresponding to the sentiment of the user as reflected in the post. Scoring is established in connection with base unique word scores and classifications provided to the probability engine at step 506. For example, if the user posted that “I loved the Italian meal at Luciano's last night”, the post would be rated as a strong positive for sentimental value. Once the sentiment score is determined, it is stored at step 509 with the post in user area 117. Next, the post is parsed and tokenized at step 511 by breaking the post into sentences, associated phrases and/or words. A stored dictionary of words, constructs, phrases and other language types shown at step 513 is used as an input to tokenizing step 511 to compare parts of the broken down post. Dictionary 513 is a dynamic list that continues to grow as more posts are analyzed. As new posts introduce new words, constructs, phrases and other language types, they are added to dictionary 513 for future analysis. Dictionary 513 becomes more robust and improves over time to produce better compare results the longer it is in use. Depending on the chosen parsing method, step 511 may be repeated multiple times and can happen at various steps within the process of FIG. 5.

The order of tokenizing and scoring is flexible. In particular, step 511 may occur before scoring 505. This flexibility is reflected in FIG. 5 with arrow 514 pointing directly from step 503 to step 511. If the route of arrow 514 is followed instead of the direct routing from step 503 to step 505 as described above, once tokenization at step 511 is performed, the tokenized post is routed back to step 505 where it is scored. From there, the tokenized parse may be looped back around multiple times depending on the chosen parsing method. For example, there could be different scoring engines configured to score different attributes such as hobbies, location, personality, etc.—each engine that scores may be unique. Alternatively, the same data can be scored by the scoring engine multiple times. A paragraph may be scored at step 505. Then it may be tokenized into sentences and sent back through the scoring step 505 to score those sentences. Another set of loops through the scoring engine may score individual parts of the sentences.

At step 515, tokens are categorized into two categories: 1) ones that have been previously analyzed; or 2) ones that have not been seen before. For those that have been previously analyzed, they are passed through step 517 to step 519 where the token is scored in context to previously developed intelligence and scores. The scoring is performed using an intelligence engine at step 521 that continues to gather information from all token scores previously established. Scoring can be on a number of different scales, but the intent is to capture the value of the token relative to other tokens in the system. For example, the user post “Happy new year John!” may result in generating a positive sentimental score, but may not be given a lot of weight since it doesn't provide a lot of insights into personal behavior or a user's character. While, another post stating “I hate the Pittsburgh Steelers” generates a strong negative sentimental score and also provides profile data that can be used to assist in assessing compatibility with another user.

Referring to step 515 of the flowchart of FIG. 5, tokens that have not been seen before are routed through step 523 for scoring at step 525. The scoring at step 525 is similar to the scoring at step 519 except that the analysis is performed using base unique word scores and classifications that are preset and are similarly applied by the probability engine at step 507. Once a never before seen token is scored, that information is fed back to the intelligence engine at step 521 for future reference and to grow the dictionary over time. Adding previously unseen tokens permits a more accurate rating of tokens in the future. The scores for tokens in steps 519 and 525 are then collected and stored at step 527 in user area 117 with the analysis of the particular post ending at step 529.

To increase the accuracy of the tokenization process, it should be understood that compatibility server 107 may, at predetermined time intervals, be programmed to go back to posts that may be stored in user area 117 and re-rate tokens based on an expanded dictionary that has grown over time. As previously mentioned, older posts may be weighted less than newer posts, but upgraded dictionary information developed through the collection of newer posts may permit a revised user profile that is more likely to lead to increased success in predicting compatibility.

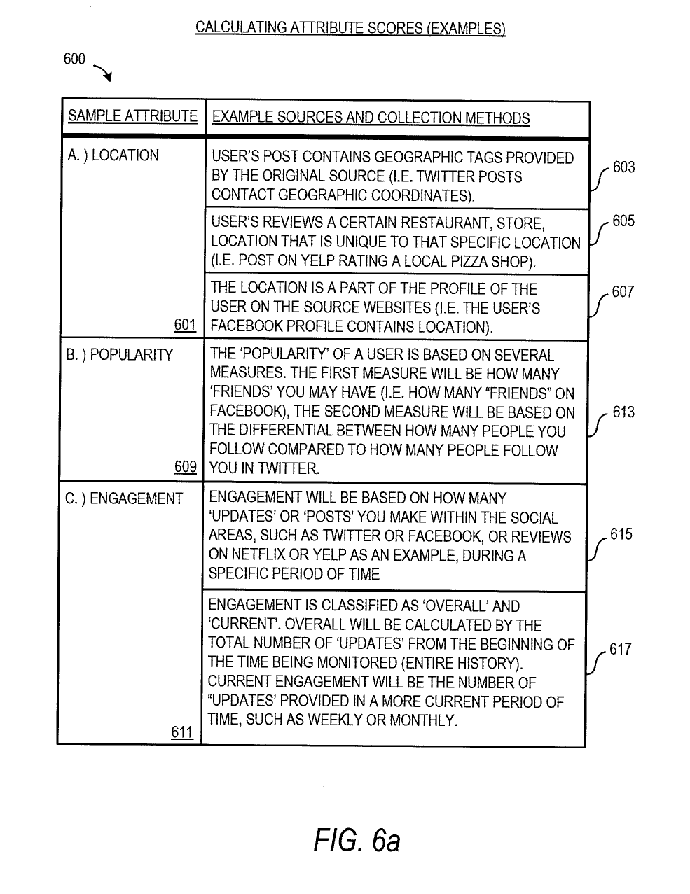

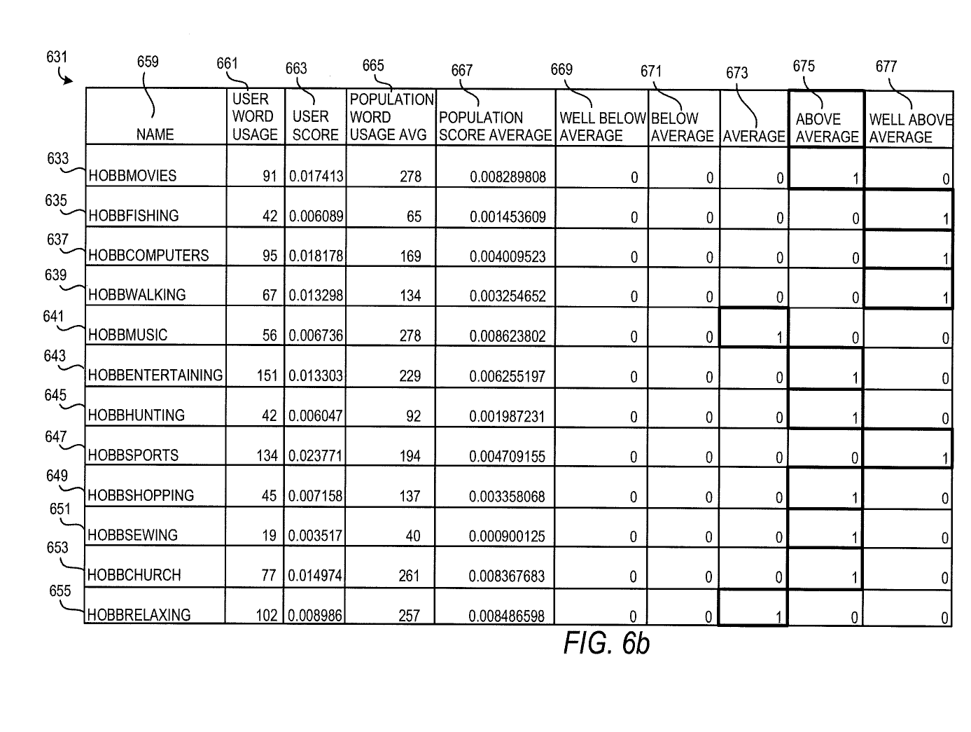

FIG. 6a shows a table 600 illustrating sample attributes with associated example sources and methods of collection. In the left column, a sample attribute is listed. These attributes, for example, may be “location,” “popularity,” “engagement,” or other attributes that are useful in developing a user profile. “Location” 601 identifies where a user lives, works or otherwise spends time. In the first example for location 603; a user may identify location through geographic tags or coordinates as is automatically done on Twitter. As shown in the second entry for location 605, the fact that a user reviewed a certain restaurant is evidence that the user spent time in the location of the restaurant. This information may be gathered in a post where the user reviewed the restaurant on Yelp or another website where ratings can be input. A third example of location 607 is where users input location information about themselves directly, such as on Facebook where “hometown” is listed.

In the same way that location information may be detected and stored, other types of information is also handled. The chart of FIG. 6a shows two other examples—one for “popularity” 609 and the other for “engagement” 611. As can be seen in the chart, popularity may be based on a number of factors such as how many friends a user has on Facebook 613. Or, it may relate to the number of people that a user follows on Twitter compared to the number of people who follow the user. “Engagement” 611 is a measure of the number of updates or posts that are made by a particular user 615. Some users religiously input many posts each day on Facebook or Twitter, while others may only “engage” the social networking site once a week or even less often. Understanding and scoring engagement guides in developing the accuracy of a user profile as weighting recent posts more heavily will impact the overall profile. Engagement is classified as “overall” or “current” 617 where overall is the total number of updates over the entire history of collected posts while current is the number of updates in a recent period such as the past week or month.

FIG. 6b is a simplified sample chart showing a limited number of sub-attributes that may otherwise be included in a larger comprehensive attribute profile where the attributes are scored based on an aggregation of all of the scores of the tokens in that category. It should be understood that the complete chart may contain hundreds or thousands of sub-attributes and attributes, and that sub-attributes and attributes may be added to or removed from the chart at any time.

Sample chart 631 shows a listing of different hobbies 633-655 (sub-attributes) that are part of a total hobby attribute. For example, the sub-attribute HobbyMovies is shown as row 633. Chart 631 also includes columns for Name 659, user word usage 661 (number of times a particular word under consideration was used), user score 663, population word usage average 665 (number of times a particular word under consideration was used on average by the general population), population score average 667 (average score of users in the general population for the use of the particular word), and five columns designating a score of “1” or “0” for well below average 669, below average 671, average 673, above average 675 and well above average 677.

User score 663 for each sub-attribute may be calculated by counting how many times a user's posts contains the specific words defined in an attribute dictionary for that sub-attribute along with an associated scored sentiment of the usage of those words that provides a weighting. For example, user score 663 for the sub-attribute HobbyMovies 633 is 0.017413. It should be understood that calculating the actual number for a sub-attribute (in this case 0.017413) is a function of the sub-attribute value (e.g. hobby-movies) and a weighting that is set by the administrator for compatibility website 201, which is at the discretion of the application designers for each of the different sub-attributes. The calculation to determine the value for sub-attribute HobbyMovies of 0.017413 is as follows:

Sub-attribute Value(or “SAV”)=(w×sA)

0.017413=(w×sA)

0.017413=(0.25×0.069652)

Where:
w represents the assigned weighting factor for the particular sub-attribute; and
sA represents the particular sub-attribute value for the user.

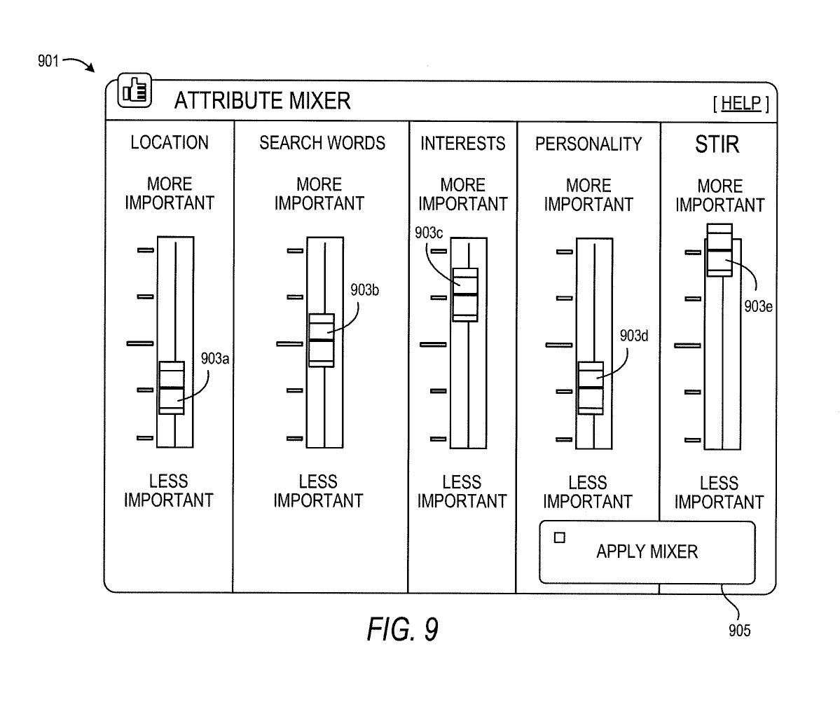

The weighting may also take into account a priority setting assigned by the user (see FIG. 9). An equation representing how an attribute score that rolls up a number of sub-attributes is calculated is as follows:

Score=(x1×A1)+(x2×A2)+(x3×A3)+(xY×AY)

Where:
x1, x2, x3 . . . xY represent the assigned weighting factor for the particular attribute; and
A1, A2, A3 . . . AY represent the particular attribute values for the user.

When compared to the population score average 667 for this same sub-attribute, this user has an above average 675 interest level in movies. The population average score is calculated by averaging all scores for the individual users on the system together for that sub-attribute. To generate a total score for an attribute such as “Hobbies,” all of the sub-attribute scores are added together and divided by the total number of sub-attributes.

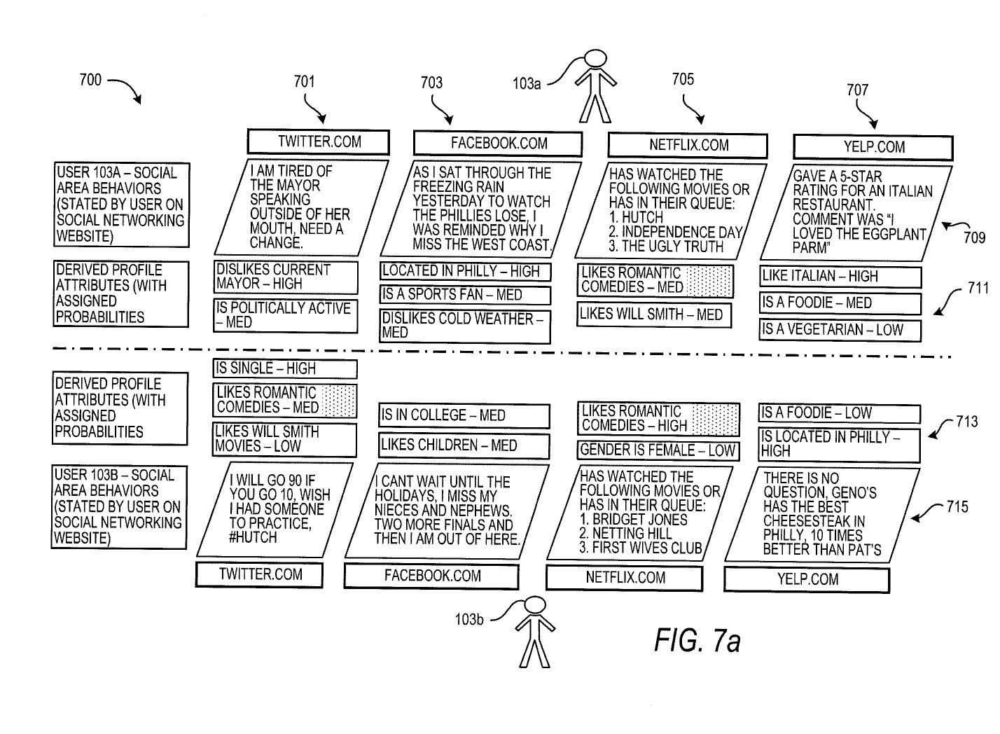

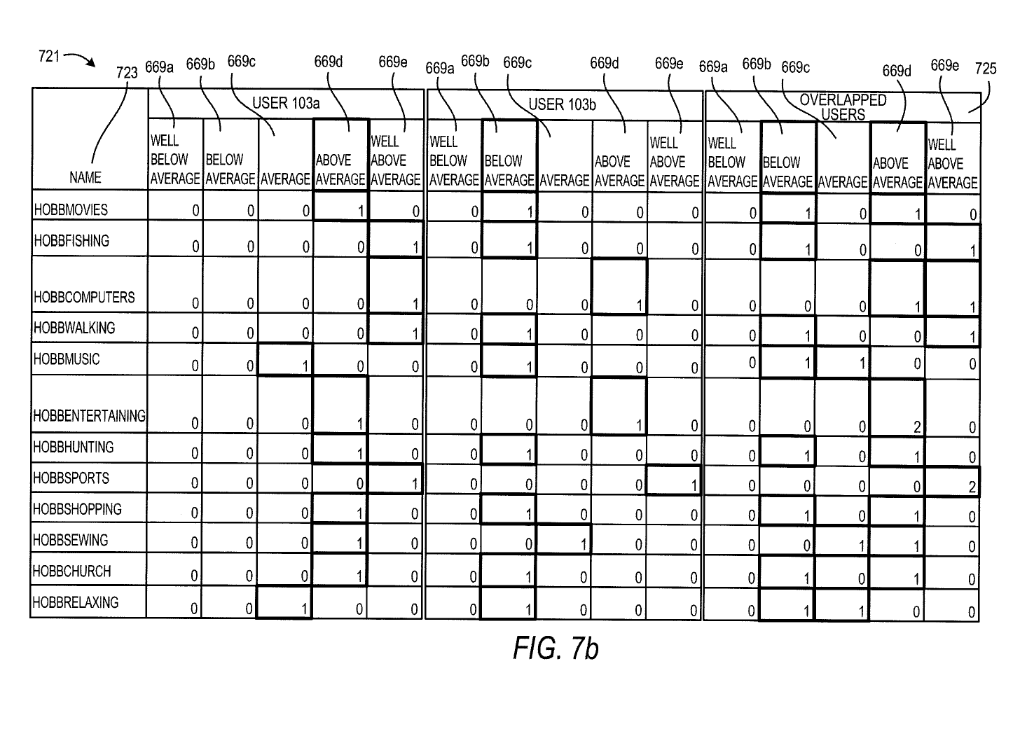

FIG. 7a is a simplified sample chart 700 for illustration purposes showing a comparison between two members of the compatibility website. As can be seen in FIG. 7a, a first user 103a, is a member of four sites as shown in columns 701, 703, 705 and 707: Twitter, Facebook, Netflix and Yelp. A second user 103b, is also a member of the same sites. It should be understood that it is not necessary for the two people for whom compatibility recommendations are to be made belong to all or even any of the same sites. The information generated from any and all sites is scored independently, and compatibility is not linked to the use of a particular site. Conclusions can be drawn from a user's posts. For example, posts for first user 103a are shown in row 709, the first of which is a Twitter post in column 701 stating: “I am tired of the Mayor speaking outside of her mouth, need a change.” Three rows 711 show the derived profile attributes for first user 103a. For the Twitter post, parsing and tokenization of the post reveals that first user 103a probably dislikes the mayor (a high rating for dislike) and may be politically active (a medium rating for politically active). By analyzing other posts of first user 103a, and similarly second user 103b, a profile can be developed from the derived attributes shown in rows 711 for first user 103a and three rows 713 for second user 103b. The attributes for second user 103b are derived from second user 103b posts in row 715 on each of the member sites in columns 701, 703, 705 and 707. Just because there is a match or even two matches between two users, as there is between first user 103a and first user 103b on FIG. 7a (located in Philly, like romantic comedies) does not mean these two users will receive a compatibility recommendation. Rather, the entire history of posts for each user is considered in generating a profile. From that profile, a compatibility rating can be generated and recommendations can be made.

FIG. 7b is a table that greatly simplifies the comparison of the scores of a first user to a second user to arrive at a correlation score for a group of sub-attributes that are used to generate a total score for the Hobby attribute. Sub-attributes of the hobby attribute are shown in name column 723. Two users 103a and 103b are shown with corresponding data in five columns for each user as described in FIG. 6b—well below average 669, below average 671, average 673, above average 675 and well above average 677. The scores of user 103a and user 103b are added together and the result is placed in the overlapped users section 725. A score of 2 in the overlapped user section reflects a direct and strong correlation between the users. Scores of 1 that are adjacent to each other shows some correlation and scores of 1 that are apart show little or no correlation. Scores of sub-attributes are aggregated as described above to arrive at a single value for each attribute for a particular user. Aggregation is accomplished by grouping various attributes into collections of attributes. For example, the hobbies: football, baseball, and hockey may be grouped in an aggregated attribute such as: Sports. Similarly, attributes such as anxiety, anger, and sadness may be grouped and aggregated into a personality attribute.

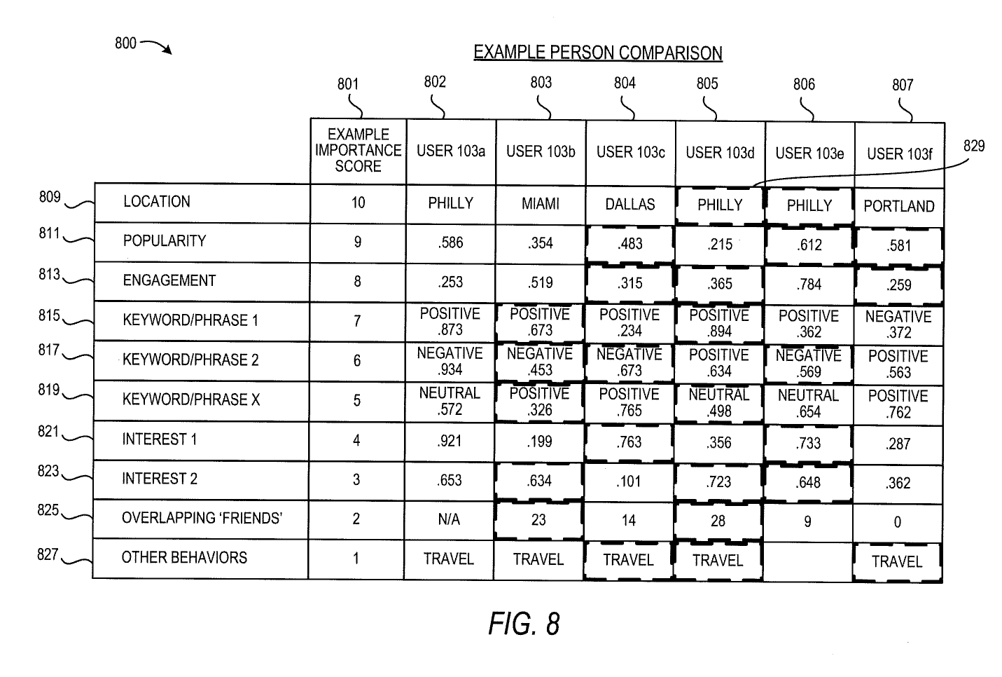

FIG. 8 is a sample table 800 showing users 103 with subject matter attributes for which they have posted, and the accompanying scoring for those different profile attributes. These attribute scores are used by the system to find compatibility matches but are not visible to users 103 of the system. For example, it has been determined that user 103a is located or otherwise spends time in Philadelphia (column 802, row 809) while users 103b, user 103c, user 103d, user 103e and user 103f are located respectively in Miami, Dallas, Philadelphia, Philadelphia and Portland (row 809, columns 803, 804, 805, 806 and 807). User 103a has a popularity score of 0.586 (column 802, row, 811), while users 103b 103c, 103d, 103e and 103f have respective popularity scores of 0.354, 0.483, 0.215, 0.612 and 0.581 (row 811, columns 803, 804, 805, 806 and 807). Other attributes for each of the users on the chart can be identified in rows 813-827.

A chart of this type may be any size and can be expanded to include all users of compatibility website 201. Recommendations can be generated from such a chart by keying off the particular attributes and the information input by the users. For example, it may be determined that the most important attribute is location because the users need to be co-located to be compatible. This is likely true if the compatibility being sought is for dating purposes. However, it may not necessarily be the case if compatibility relates to users who are looking to be connected for professional or commercial purposes. In the example of FIG. 8, importance of a particular attribute is shown in column 801. A high importance is placed on location (column 801, row 809) while “other behaviors” (column 801, row 827) has a low importance rating. The importance of different attributes varies depending on the interests of the users. Importance ratings may change over time depending on the content of a user's posts or associated matching algorithm.

As can be seen from FIG. 8, user 103a appears to be most compatible with user 103d as indicated by seven highlighted categories in column 805 where a highlighted category (bolding around the border of the corresponding box) indicates a high correlation between users. As an example, user 103a and user 103d have a highly correlated score in the location row 809 because they both are either in Philly or spend time in Philly. Therefore, box 829 is highlighted. The next most compatible users with user 103a are ranked in the following order: user 103e (five highlighted categories), user 103c (five highlighted categories), user 103b (5 highlighted categories) and user 103f (three highlighted categories). By gathering and scoring posts over time, an accurate profile of a particular user can be developed. The profile can then be used to find compatible matches that are likely to lead to long term successful relationships.

FIG. 9 shows an “attribute mixer” 901 available to a user 103 when they set up their personal profile on website 201. Attribute mixer 901 includes a number of slider switches 903a-e that are adjustable by the user to allow a user to decide what attributes are more heavily weighted in comparison to others. Switches 903a-e are used to represent the relative weighting of attributes such as location (903a), search words (903b), interests (903c), personality (903d) and stir (903e). Switches 903 can be slid higher to give greater weight to an attribute and lower to give lesser weight to an attribute. While switches 903 are shown as sliders, it should be understood that this is only one representation of switches 903 and they may take many other forms such as a dial or an up/down button. In addition, attribute mixer 901 may include a greater number of switches 903 or fewer switches 903.

Each switch 903 represents an individual attribute as described with respect to FIG. 6a. For example, location 601 is typically an important attribute for a user because the user would like to find compatible matches with other users in their location. In the example of FIG. 9, location switch 903a is placed on the left side of attribute mixer 901 because it is the first attribute that user 103 may want to consider when setting switches 903. Search words switch 903b is adjacent to location switch 903a and is set to consider certain search words entered by other users that user 103 may be particularly interested in. For example, user 103 may be a New England Patriots fan who is interested in finding compatibility matches with other Patriots fans. By choosing the words “New England Patriots” as specified search words, user 103 can assign a relative weighting to those particular search words when the system finds compatibility matches. Similarly, an interest switch 903c and a personality switch 903d can be adjusted as desired. A “stir” switch 903e is also shown. Stir switch 903e is like a wild card switch and uses a set of predefined factors configured by the system administrator. For example, stir switch 903e may consider factors such as popularity, engagement, and vocabulary. Once a user makes a final decision on the switch settings, he clicks on the “apply mixer” button 905 to lock in the settings.

User 103 may make as many changes to switches 903 as desired. Each time one or more of switches 903 are adjusted, the compatibility matches delivered by the system will change. By experimenting with the settings of switches 903, user 103 will learn over time what settings work best to deliver the best compatibility matches that reflect their individual preferences.

The operation of the social networking application will now be described with reference to FIGS. 1-9. Initially, a user 103 sets up a profile and authorizes server 107 to gather information about the user from a number of sources such as social network website server 111 which may be running any one of a number of applications including Facebook, Twitter, Netflix, etc. Once the user profile has been set up, information about user 103 is gathered from the applications and stored in user profile storage database 113 as user 103 goes about his daily routine. Each piece of information posted by user 103 is tokenized and scored. These token scores are then aggregated into sub-attribute categories that are in turn scored. And, the sub-category scores are aggregated to provide a total score for a particular attribute. Once an attribute is scored, it may be compared to the corresponding attribute scores of other users. Weighting of different attributes is adjusted by the user using attribute mixer 901. Based on the comparison of the attributes between users and the assigned weighting of those attributes, a list of compatibility matches is provided to the user. If the user adjusts the weightings of the attributes by using the switches on attribute mixer 901, a different set of compatibility matches will be delivered to the user. It should also be understood that since the system operates dynamically as new posts are tokenized and scored, compatibility matches are updated on a continuous basis depending on the number and quality of posts by the user and other users.

While the invention has been described with respect to the figures, it will be appreciated that many modifications and changes may be made by those skilled in the art without departing from the spirit of the invention. Any variation and derivation from the above description and drawings are included in the scope of the present invention as defined by the claims.

What is claimed is:

1. A system comprising:
an input device for use by a user to access a network and for inputting information;
at least one network application running on the network for receiving information input by the user wherein the user information is posted for viewing on a network site by at least one other person;
a computer server connected to the network and having access to the at least one network application for retrieving the information input and posted by the user;
a storage device connected to the computer server for storing the information input and posted by the user wherein the user information is scored to generate a user profile; and
a compatibility selection component running on the computer server for comparing scored information between a plurality of users and making individual compatibility recommendations for each user.

2. The system of claim 1 wherein the network application is made available to users in the form of a website with social networking functionality.

3. The system of claim 1 wherein the system updates the user profile on a continuous basis as new information input by the user is received.

4. The system of claim 3 wherein the system weights user information for scoring depending on various attributes including one or more of the following: location, popularity, engagement, keywords, user interests, overlapping friends, and other behaviors.

5. The system of claim 4 wherein the system weights newer user information more heavily than older user information input by the user when updating the user profile.

6. The system of claim 4 wherein the weighting of user information is adjustable by the user.

7. The system of claim 1 further comprising:
a tokenizing component for parsing information input by the user into one or more tokens and assigning a score to each token for one or more sub-attributes to which a token relates; and
an scoring component for producing one or more attribute scores by combining all scores for a user for a tokens related to an sub-attribute.

8. The system of claim 7 wherein the sub-attribute scores are aggregated by the scoring component to generate an attribute score for each attribute.

9. The system of claim 1 wherein the user authorizes access to the network application so that the computer server may receive user information from the network application.

10. The system of claim 7 wherein the compatibility selection component for calculating sub-attribute scores for a plurality of sub-attributes and aggregating those scores with weighting components to make individual compatibility recommendations between users.

11. A method comprising:
inputting information to a network application running on a network;
posting the information on a network site that can be viewed by a user who input the information and at least one other person;
retrieving the information through a network from the network application; and
scoring the information to generate a user profile of the user who input the information.

12. The method of claim 11 further comprising generating a compatibility recommendation between at least two users.

13. The method of claim 11 further comprising updating the user profile on a continuous basis as new information input by the user is received.

14. The method of claim 13 further comprising weighting newer user information more heavily than older user information input by the user when updating the user profile.

15. The method of claim 11 further comprising weighting user information for scoring depending on attributes including one or more of the following: location, popularity, engagement, keywords, user interests, overlapping friends, and other behaviors.

16. The method of claim 15 further comprising adjustments to weighting made by the user.

17. The method of claim 11 further comprising:
tokenizing user information into one or more tokens and assigning a score to each token for one or more sub-attributes to which a token relates; and
producing one or more sub-attribute scores by combining all scores for a user for a group of tokens related to a sub-attribute.

18. The system of claim 17 wherein the sub-attribute scores are aggregated by the scoring component to generate an attribute score for each attribute.

19. The system of claim 17 further comprising comparing sub-attribute scores of at least two users by aggregating scores for a set of tokens related to a sub-attribute and making compatibility recommendations between users.

20. The system of claim 11 further comprising authorizing access to the network application so that the computer server may receive user information from the network application.
